(19) United States
(12) Patent Application Publication
(10) Pub. No.: US 2026/0145348 A1
(43) Pub. Date: May 28, 2026

(54) A MOUNTING ASSEMBLY

(71) Applicant: KONINKLIJKE PHILIPS N.V., EINDHOVEN (NL)

(72) Inventors: ALWIN WILLIAM DE VRIES, Zuidlaren (NL); MARCUS CORNELIS PETRELLI, Groningen (NL); MARCUS FRANCISCUS EIJKELKAMP, Peize (NL)

(21) Appl. No.: 19/121,194

(22) PCT Filed: Oct. 18, 2023
(86) PCT No.: PCT/EP2023/078932

§ 371 Date: Apr. 15, 2025

(30) Foreign Application Priority Data
Oct. 25, 2022 (EP) 22203684.0

(51) Int. Cl. B26B 19/04

(52) U.S. Cl. CPC B26B 19/048

(57) ABSTRACT

According to an aspect, there is provided a mounting assembly (20) for a hair cutting appliance (10), the mounting assembly comprising: a head (22) comprising a body (24), extending along an elongate (axis (50), and a driving bridge (26), the head being configured to receive a cutting unit, wherein the driving bridge is configured to couple to the cutting unit and to reciprocally move relative to the body along the elongate axis; a base (30) connected to the head with a first pivoting mechanism (32); a driving unit (34) comprising a driving (axle (36) and a socket 38, the driving axle comprising an eccentric pin (42) cooperating with the driving bridge to impart reciprocating motion to the driving bridge, and the socket being configured to cooperate with a motor (14); wherein the first pivoting mechanism comprises: a base bearing surface (44) on the base, a counterpart (40) coupled to the head, the counterpart comprising a counterpart bearing surface (46), wherein the base bearing surface and the counterpart bearing surface are configured to cooperate to permit relative rotational sliding movement of the base and the head about only a fixed rotational axis (60) which is perpendicular to the elongate axis.

### FIELD OF THE INVENTION

The present disclosure relates to a mounting assembly for a hair cutting appliance and a hair cutting appliance.

### BACKGROUND OF THE INVENTION

Hair cutting appliances typically comprise a cutting unit, and it is beneficial to enable the cutting unit to be pivotable relative to a handle, in order to be able to follow the contours of a user's skin surface to create optimal contact between the user's skin and the cutting unit, to attain the best cutting performance.

### SUMMARY OF THE INVENTION

According to a first specific aspect, there is provided a mounting assembly for a hair cutting appliance, the mounting assembly comprising:
a head comprising a body, extending along an elongate axis, and a driving bridge, the head being configured to receive a cutting unit, wherein the driving bridge is configured to couple to the cutting unit and to reciprocally move relative to the body along the elongate axis;
   a base connected to the head with a first pivoting mechanism;
   a driving unit comprising a driving axle and a socket, the driving axle comprising an eccentric pin cooperating with the driving bridge to impart reciprocating motion to the driving bridge, and the socket being configured to cooperate with a motor;
   wherein the first pivoting mechanism comprises:
      a base bearing surface on the base,
      a counterpart coupled to the head, the counterpart comprising a counterpart bearing surface,
      wherein the base bearing surface and the counterpart bearing surface are configured to cooperate to permit relative rotational sliding movement of the base and the head about only a fixed rotational axis which is perpendicular to the elongate axis.

One of the base bearing surface or the counterpart bearing surface comprises an inner surface of a slot having a curvature about the fixed rotational axis. The other of the base bearing surface or the counterpart bearing surface comprises an outer surface of a pin which is configured to be received within the slot.

A fixed rotational axis is intended to mean a rotational axis which is stable, and does not move relative to the head or the base. The distance between the fixed rotational axis and a point of contact of the cutting unit with the skin may be at most 20 mm. The elongate axis and the fixed rotational axis may not cross. The maximum distance between either the driving bridge or the socket, and the fixed rotational axis may be 5 mm.

It may be that the base bearing surface has a curvature of a first radius about the fixed rotational axis. It may be that the counterpart bearing surface has a curvature of a second radius about the fixed rotational axis. It may be that the first radius is the same as the second radius such that the counterpart bearing surface is configured to contact, and cooperate with, the base bearing surface to permit relative rotational sliding movement between the base and the counterpart about the rotational axis.

It may be that the base bearing surface or the counterpart bearing surface comprises a recessed section to reduce a contact surface area between the base and the counterpart. There may be at least two contact points between the counterpart bearing surface and the base bearing surface on either side of the recessed section.

It may be that there are two separate slots and two corresponding pins which are configured to be received in respective slots.

It may be that the counterpart comprises a foundation which is part of a second pivoting mechanism for pivoting the head relative to the base about a second rotational axis which is parallel to the elongate axis.

It may be that the foundation is a first bar of a four-bar linkage, the body comprises a second bar of a four-bar linkage, and the foundation and the body are coupled together with a third bar and a fourth bar of a four-bar linkage.

It may be that the fixed rotational axis is positioned between the driving bridge and the socket.

According to a second aspect, there is provided a hair cutting appliance comprising: a mounting assembly according to the first aspect; a motor configured to be coupled to the driving unit; and a handle configured to be attached to the mounting assembly.

These and other aspects will be apparent from and elucidated with reference to the embodiment(s) described hereinafter.

### BRIEF DESCRIPTION OF THE DRAWINGS

Exemplary embodiments will now be described, by way of example only, with reference to the following drawings, in which:

FIG. 1 schematically shows a front view of a hair cutting appliance; and

FIGS. 2-4 schematically show front views of first, second, and third example mounting assemblies.

### DETAILED DESCRIPTION OF THE EMBODIMENTS

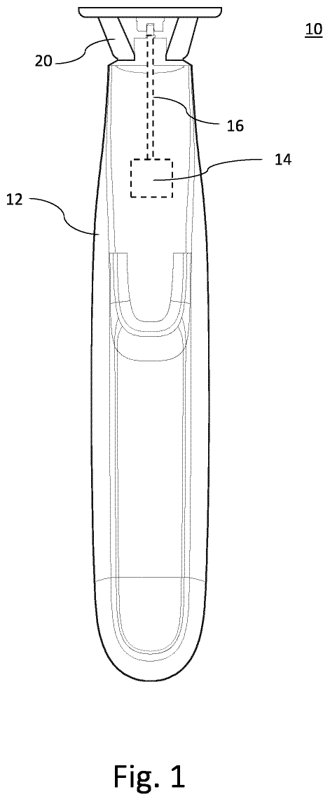

FIG. 1 shows a hair cutting appliance 10 comprising a handle 12 for a user to hold the hair cutting appliance 10, and a mounting assembly 20, attached to the handle 12. A motor 14 is disposed within the handle 12, and a transfer shaft 16 extending from the motor 14 is coupled to the mounting assembly 20.

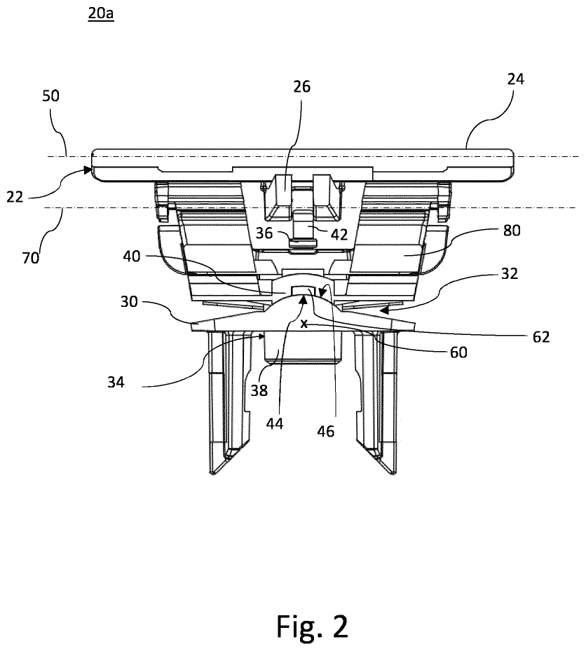

FIG. 2 shows a first example mounting assembly 20a for attaching to the handle 12 of the hair cutting appliance 10.

The mounting assembly 20a comprises a head 22 comprising a body 24 extending along an elongate axis 50 and a driving bridge 26. The head 22 is configured to receive a cutting unit, such as a blade. The driving bridge 26 is configured to reciprocally move relative to the body 24 along the elongate axis 50. The driving bridge 26 is also coupled to the cutting unit, so that, when the driving bridge moves reciprocally relative to the body 24, the cutting unit is also moved reciprocally relative to the body 24, to enable it to cut hairs.

The first example mounting assembly 20a comprises a driving unit 34 with a driving axle 36 and a socket 38 fixed together. The socket 38 is configured to cooperate with the motor 14, via the shaft 16, to impart rotary motion to the socket 38 and the driving axle 36. The driving axle 36 comprises an eccentric pin 42 which is received in a channel of the driving bridge 26, to cooperate with the driving bridge 26, to impart reciprocating motion to the driving bridge 26 by rotation of the driving axle 36. The driving unit 34 is therefore configured to transfer rotary motion of the motor into reciprocating motion of the driving bridge 26. The socket 38 is configured to receive, and cooperate with, the shaft 16 at various different angles, so that the socket 38 can pivotably move relative to the motor 14 without detrimentally impacting the ability of the driving unit 34 to transfer rotary motion of the motor 14 into reciprocating motion of the driving bridge 26.

The first example mounting assembly 20a comprises a base 30 which is connected to the head 22 with a first pivoting mechanism 32. The base 30 is configured to couple to the handle 12.

In this example, the first pivoting mechanism 32 comprises the base 30 and a counterpart 40 which is moveably coupled to the head 22. The first pivoting mechanism 32 is configured to permit relative movement between the head 22 and the base 30 about only a fixed rotational axis 60 which is perpendicular to the elongate axis 50.

The first pivoting mechanism 32 comprises a base bearing surface 44 on the base 30 and a counterpart bearing surface 46 on the counterpart 40. The base bearing surface 44 and the counterpart bearing surface 46 cooperate to permit relative rotational sliding movement of the base 30 and the counterpart 40 coupled to the head 22 about only a fixed rotational axis 60 (shown as going into the page on FIG. 2). The fixed rotational axis 60 is substantially perpendicular to the elongate axis 50. In this example, the fixed rotational axis 60 is positioned between the driving bridge 26 and the socket 38, so that a connection between the motor 14 and the socket 38 (in this case the shaft 16), does not inadvertently decouple from the socket 38 when the head 22 is rotated about the fixed rotational axis 60 relative to the base 30. In this example, the fixed rotational axis 60 is at a receiving face of the socket 38. In other examples, the fixed rotational axis may be within 5 mm from the receiving face of the socket 38. The closer the fixed rotational axis to the socket 38, the less likely that the socket 38 will decouple from the shaft of the motor 14 during pivoting of the counterpart 40 from the base 30.

In this example, the base bearing surface 44 is a concave surface having a first radius about of curvature the fixed rotational axis 60, and the counterpart bearing surface 46 is a convex surface having a second radius of curvature about the fixed rotational axis 60. In this example, the first radius and the second radius are the same such that the convex surface of the counterpart bearing surface 46 corresponds to the concave surface of the base bearing surface 44, and the base bearing surface 44 is in sliding contact with the counterpart bearing surface 46, such that the surfaces permit relative rotational movement about only the fixed rotational axis 60 between the base 30 and the counterpart 40.

In this example, the counterpart bearing surface 46 comprises a recessed section 62 to reduce a contact surface area between the base 30 and the counterpart 40, to thereby reduce complexity of the parts and reduces the need for high precision machining to make the surfaces coincide. The recessed section 62 of the counterpart bearing surface 46 in this example is positioned such that the counterpart bearing surface 46 still comprises two surfaces on opposing sides of the recessed section 62, such that there are two contact points or contact lines between the counterpart bearing surface 46 and the base bearing surface 44 on either side of the recessed section 62. It will be appreciated that there may be more than one recessed section, and that there may be more than two contact points.

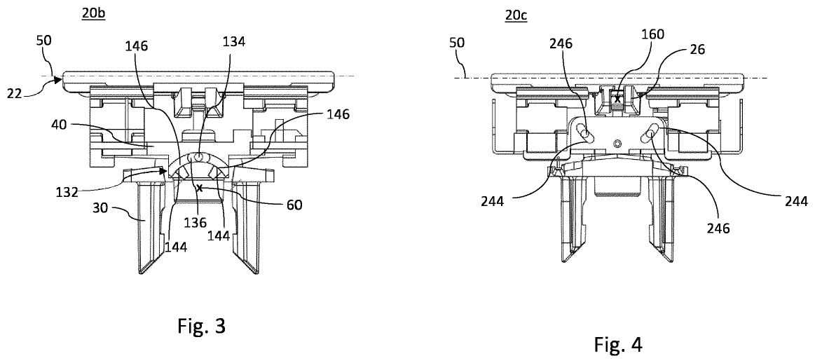

In some examples, the recessed section may be in the base bearing surface or in both surfaces. In examples, where both surfaces comprise recessed sections, the length of one of the sides must be double the displacement of the bearing, otherwise the counterpart and base would decouple (for example in FIG. 3). In other examples, the bearing surfaces may be continuous such that there is no recessed section.

In this example, the counterpart 40 is moveably coupled to the head 22 with a second pivoting mechanism 80, which is configured to permit relative rotational movement between the head 22 and the base 30 about a second rotational axis 70, which is parallel to the elongate axis 50. In this example, the counterpart 40 comprises a foundation which is a part of the second pivoting mechanism 80. In this example, the foundation is a first bar of a four-bar linkage, the body 24 comprises a second bar of a four-bar linkage, and the foundation and the body 24 are coupled together with a third bar and a fourth bar of a four-bar linkage. In this example, the second rotational axis 70 is therefore a virtual axis, which moves dependent on the relative position of the four-bar linkage.

In other examples, the foundation and the base of the head may be coupled with a simple pivot which allows pivoting movement about the second rotational axis 70, where the second rotational axis is fixed.

In other examples, the counterpart may be fixedly coupled to the head, so that it is unitary with the head, and so that the head may not be moveable relative to the base about a second rotational axis parallel to the elongate axis. In other examples, although the head may not be moveable relative to the base about a second fixed axis, the base may be moveable relative to the handle about an axis parallel to the elongate axis, such that the head is still moveable relative to the handle about two perpendicular axes.

FIG. 3 shows a second example mounting assembly 20b. The second example mounting assembly 20b is similar to the first example mounting assembly 20a, but differs in having a different first pivoting mechanism 132 which further connects the head 22 and the base 30. In this example, the first pivoting mechanism 132 is similar to the first pivoting mechanism 32 in that it comprises the base 30 and the counterpart 40, having a base bearing surface 144 and a counterpart bearing surface 146, but differs in that the counterpart bearing surface 146 is disposed on opposing sides of a slot 136 in the counterpart 40, and the base bearing surface 144 comprises two protrusions on the base 30 (this could be considered to be both the base bearing surface 144 having a recessed section and the counterpart bearing surface 146 having a recessed section). It differs further in additionally having a pin 134 which is a part of the base 30 which is received within the slot 136. In other examples, the pin may be a part of the counterpart while the slot may be a part of the base. The pin 134, in this example, is only loosely received in the slot 136 in this example to avoid over-constraining the system. In other words, the slot 136 is made wider than the pin 134 so that the pin 134 is not necessarily in contact with an inner surface of the slot 136 unless the counterpart 40 and the base 30 are pushed towards one another or pulled away from one another, in which case the pin 134 acts against an inner surface of the slot 136 to prevent decoupling of the base 30 from the counterpart 40. The pin 134 and the slot 136 can also be used to define end points of rotation, to prevent over rotation of the counterpart 40 relative to the base 30. The pin may have a circular section, or a curved section corresponding to the curvature of the slot. In other examples, the counterpart bearing surface may comprise the inner surface of the slot, while the base bearing surface may comprise the outer surface of the pin.

FIG. 4 shows a third example mounting assembly 20c which is similar to the second example mounting assembly 20b, but differs in comprising a different base bearing surface 244 and counterpart bearing surface 246 which are inverted so that the base 30 and the counterpart 40 are configured to rotate about a different fixed rotational axis 160 which, in this example, is in the centre of the driving bridge 26. In this example, the base bearing surface 244 comprises an inner surface of two slots, and the counterpart bearing surface 246 comprises an outer surface of two corresponding pins, which are configured to be received in each slot respectively. In other examples, the counterpart bearing surface may comprise the inner surfaces of the two slots, while the base bearing surface may comprise the outer surfaces of the two pins. In yet other examples, there may be only a single slot and pin, or more than two slots and corresponding pins. In essence, the embodiment of FIG. 4 combines the embodiments of FIGS. 2 and 3 together, where the pin and slot act as both the bearing surfaces and the constraint to prevent separation of the counterpart 40 and the base 30. In this example, the fixed rotational axis 160 may be within 5 mm from the driving bridge 26.

A fixed rotational axis, as referred to herein, is intended to mean a rotational axis which is stable and does not move relative to the head 22 or the base 30. In this example, the distance between the fixed rotational axis 60, 160 and a point of contact of the cutting unit with the skin (e.g., a top surface of the head 22 furthest from the base 30) may be at most 20 mm. In some examples, the second rotational axis 70 and the elongate axis 50 may not cross the fixed rotational axis 60, 160. In other words, the fixed rotational axis 60, 160 may not be in line with a part of the head 22 configured to receive the cutting unit. Variations to the disclosed embodiments can be understood and effected by those skilled in the art in practicing the principles and techniques described herein, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored or distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A mounting assembly for a hair cutting appliance, the mounting assembly comprising:
a head comprising a body, extending along an elongate axis, and a driving bridge, the head being configured to receive a cutting unit, wherein the driving bridge is configured to couple to the cutting unit and to reciprocally move relative to the body along the elongate axis;
a base connected to the head with a first pivoting mechanism;
a driving unit comprising a driving axle and a socket, the driving axle comprising an eccentric pin cooperating with the driving bridge to impart reciprocating motion to the driving bridge, and the socket being configured to cooperate with a motor;
wherein the first pivoting mechanism comprises:
a base bearing surface on the base,
a counterpart coupled to the head, the counterpart comprising a counterpart bearing surface,
wherein the base bearing surface and the counterpart bearing surface are configured to cooperate to permit relative rotational sliding movement of the base and the head about only a fixed rotational axis which is perpendicular to the elongate axis
wherein one of the base bearing surface or the counterpart bearing surface comprises an inner surface of a slot having a curvature about the fixed rotational axis, and wherein the other of the base bearing surface or the counterpart bearing surface comprises an outer surface of a pin which is configured to be received within the slot.

2. A mounting assembly according to claim 1, wherein:
the base bearing surface has a curvature of a first radius about the fixed rotational axis; and
the counterpart bearing surface has a curvature of a second radius about the fixed rotational axis,
wherein the first radius is the same as the second radius such that the counterpart bearing surface is configured to contact, and cooperate with, the base bearing surface to permit relative rotational sliding movement between the base and the counterpart about the rotational axis.

3. A mounting assembly according to claim 2, wherein the base bearing surface or the counterpart bearing surface comprises a recessed section to reduce a contact surface area between the base and the counterpart.

4. A mounting assembly according to claim 3, wherein there are at least two contact points between the counterpart bearing surface and the base bearing surface on either side of the recessed section.

5. A mounting assembly according to claim 1, wherein there are two separate slots and two corresponding pins which are configured to be received in respective slots.

6. A mounting assembly according to claim 1, wherein the counterpart comprises a foundation which is part of a second pivoting mechanism for pivoting the head relative to the base about a second rotational axis which is parallel to the elongate axis.

7. A mounting assembly according to claim 6, wherein the foundation is a first bar of a four-bar linkage, the body comprises a second bar of a four-bar linkage, and the foundation and the body are coupled together with a third bar and a fourth bar of a four-bar linkage.

8. A mounting assembly according to claim 1, wherein the fixed rotational axis is positioned between the driving bridge and the socket.

9. A hair cutting appliance comprising:
a mounting assembly according to claim 1;
a motor configured to be coupled to the driving unit; and
a handle configured to be attached to the mounting assembly.
